(19) United States
(12) Patent Application Publication
(10) Pub. No.: US 2024/0419102 A1
(43) Pub. Date: Dec. 19, 2024

(54) IMAGE FORMING APPARATUS

(71) Applicant: FUJIFILM Business Innovation Corp., Tokyo (JP)

(72) Inventors: Mariko SUZUKI, Kanagawa (JP); Masaaki YAMAURA, Kanagawa (JP); Akihiro TAKAHASHI, Kanagawa (JP)

(73) Assignee: FUJIFILM Business Innovation Corp., Tokyo (JP)

(21) Appl. No.: 18/529,582

(22) Filed: Dec. 5, 2023

(30) Foreign Application Priority Data
Jun. 15, 2023 (JP) 2023-098266

(51) Int. Cl. G03G 15/16

(52) U.S. Cl. CPC G03G 15/161

(57) ABSTRACT

An image forming apparatus includes an image holding unit, a transfer unit that transfers an image held by the image holding unit to a medium, a reading unit that reads an image held by the image holding unit, a supply unit that supplies, to the image holding unit, a transfer assisting material that assists transfer, and an adjustment unit that performs adjustment of an image quality based on a result of a reading operation performed by the reading unit on an image for image quality adjustment, which is held by the image holding unit, and that performs the adjustment in different ways depending on whether or not the transfer assisting material has been supplied to the image holding unit.

### CROSS-REFERENCE TO RELATED APPLICATIONS

This application is based on and claims priority under 35 USC 119 from Japanese Patent Application No. 2023-098266 filed Jun. 15, 2023.

### BACKGROUND

### (i) Technical Field

The present invention relates to an image forming apparatus.

### (ii) Related Art

Regarding an image forming apparatus in which an image of a developer on an image holding unit is electrostatically transferred and fixed to a medium such as paper so that image formation is performed, a technique described in JP2009-300618 ([0050] to [0055], FIG. 1, and FIG. 3) is known.

Described in JP2009-300618 ([0050] to [0055], FIG. 1, and FIG. 3) is a technique in which a new-product marking (M) is applied onto a surface of an intermediate transfer belt (51) by using silicon fine particles or the like at the time of factory shipment of a brand-new belt unit and in a case where an optical sensor (103) detects the new-product marking (M) at the time of replacement a belt unit, it is determined that the belt unit has been replaced with the brand-new belt unit and a reflected light reference value of the optical sensor is updated to an initial value. In JP2009-300618 ([0050] to [0055], FIG. 1, and FIG. 3), the new-product marking (M) is formed by using silicon fine particles which are also used as lubricant. Therefore, after the new-product marking (M) is detected for the first time, the new-product marking (M) is removed by a belt cleaning device (24) so that the new-product marking (M) is not detected for the second time and thereafter.

### SUMMARY

Aspects of non-limiting embodiments of the present disclosure relate to an image forming apparatus that stabilizes an image quality in comparison with a case where an image held at an image holding unit is read and image quality adjustment is performed regardless of whether or not a transfer assisting material is supplied to the image holding unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including an image holding unit, a transfer unit that transfers an image held by the image holding unit to a medium, a reading unit that reads an image held by the image holding unit, a supply unit that supplies, to the image holding unit, a transfer assisting material that assists transfer, and an adjustment unit that performs adjustment of an image quality based on a result of a reading operation performed by the reading unit on an image for image quality adjustment, which is held by the image holding unit, and that performs the adjustment in different ways depending on whether or not the transfer assisting material has been supplied to the image holding unit.

### BRIEF DESCRIPTION OF THE DRAWINGS

Exemplary embodiment(s) of the present invention will be described in detail based on the following figures, wherein:

FIG. 1 is an overall explanatory view of an image forming apparatus of Example 1;

FIG. 2 is an enlarged explanatory view of a visible image forming apparatus of Example 1;

FIG. 3 is an explanatory diagram of a control unit of Example 1;

FIG. 4 is an explanatory diagram of an example of a relationship between the amount of adhesion of a transfer assisting material and the output of a density sensor and is a graph in which the horizontal axis represents the coverage rate and the vertical axis represents the output value of the density sensor; and

FIG. 5 is an explanatory diagram showing an influence exerted by the transfer assisting material in a case where a patch image is read.

### DETAILED DESCRIPTION

Next, a specific example (hereinafter, referred to as example) of an exemplary embodiment of the present invention will be described with reference to the drawings. However, the present invention is not limited to an example as follows.

For the sake of easy understanding of the following description, in the drawings, a front-rear direction will be referred to as an X-axis direction, a right-left direction will be referred to as a Y-axis direction, and a vertical direction will be referred to as a Z-axis direction. Directions and sides represented by arrows X, −X, Y, −Y, Z, and −Z are a frontward direction, a rearward direction, a rightward direction, a leftward direction, an upward direction, a downward direction, a front side, a rear side, a right side, a left side, an upper side, and a lower side, respectively.

In addition, in the drawings, a circle with a point therein means an arrow from the back of the paper to the front of the paper and a circle with a cross therein means an arrow from the front of the paper to the back of the paper.

In the following description which will be made by using the drawings, members other than members necessary for the description are not shown as appropriate for the sake of easy understanding.

### Example 1

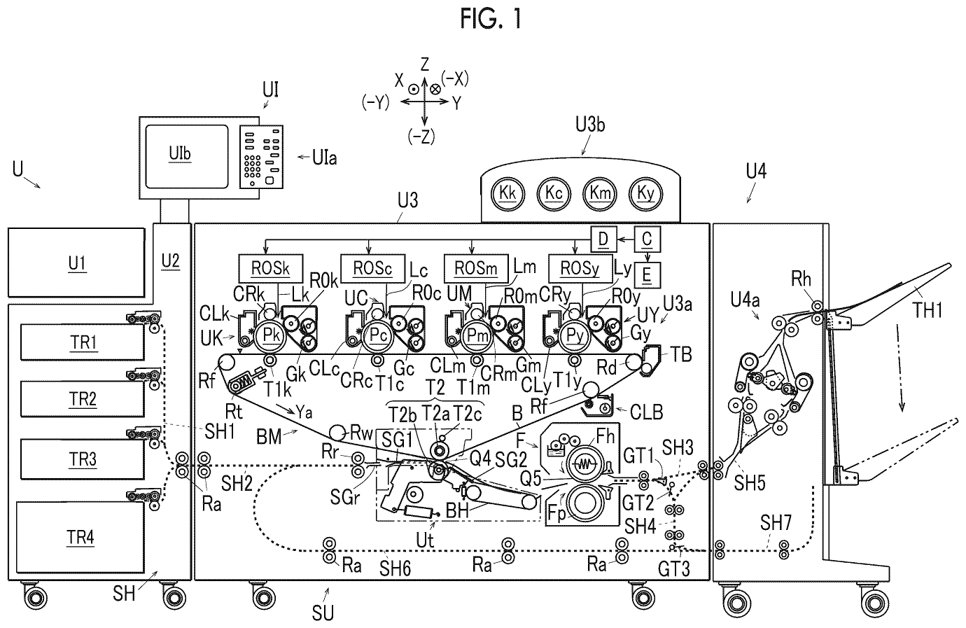

FIG. 1 is an overall explanatory view of an image forming apparatus of Example 1.

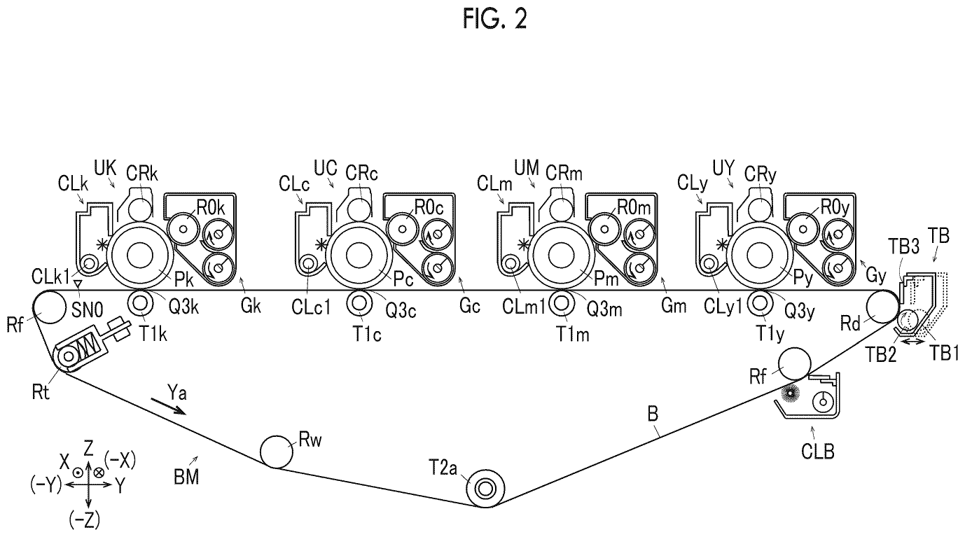

FIG. 2 is an enlarged explanatory view of a visible image forming apparatus of Example 1.

In FIG. 1, a copying machine U which is an example of the image forming apparatus includes a user interface UI which is an example of an operation unit, a scanner unit U1 which is an example of an image reading device, a feeder unit U2 which is an example of a medium supplying device, an image creating unit U3 which is an example of an image recording device, and a medium processing device U4.

### Description about User Interface UI

The user interface UI includes input buttons UIa used for the start of copying, the setting of the number of copies, and the like. Further, the user interface UI includes a display unit UIb that displays content input via the input buttons UIa and the state of the copying machine U.

### Description about Feeder Unit U2

In FIG. 1, the feeder unit U2 includes a plurality of paper feed trays TR1, TR2, TR3, and TR4 which are examples of a medium accommodation container. In addition, the feeder unit U2 includes a medium supply path SHI or the like through which a recording paper sheet S, which is an example of a medium for image recording and is accommodated in each of the paper feed trays TR1 to TR4, is transported to the image creating unit U3 after being extracted.

### Description about Image Creating Unit U3 and Medium Processing Device U4

In FIG. 1, the image creating unit U3 includes an image recording unit U3a that records an image on the recording paper sheet S transported from the feeder unit U2 based on a document image read by the scanner unit U1.

In FIGS. 1 and 2, a latent image forming device drive circuit D of the image creating unit U3 outputs, based on image information input from the scanner unit U1, a drive signal corresponding to the image information input to latent image forming devices ROSy, ROSm, ROSc, and ROSk of yellow (Y), magenta (M), cyan (C), and black (K) at a time set in advance. Photoreceptor drums Py, Pm, Pc, and Pk which are examples of image holding units are respectively disposed below the latent image forming devices ROSy to ROSk which are examples of writing units.

Surfaces of the photoreceptor drums Py to Pk rotating are uniformly charged by charging rolls CRy, CRm, CRc, and CRk, which are examples of charging units, respectively. Via laser beams Ly, Lm, Lc, and Lk which are examples of latent image writing light output by the latent image forming devices ROSy to ROSk, electrostatic latent images are formed on the charged surfaces of the photoreceptor drums Py to Pk. The electrostatic latent images on the surfaces of the photoreceptor drums Py to Pk are developed into toner images, which are examples of yellow (Y), magenta (M), cyan (C), and black (K) visible images, by developing devices Gy, Gm, Gc, and Gk which are examples of developing units.

Note that regarding developer consumed due to development in the developing devices Gy to Gk, the developing devices Gy to Gk are replenished with developer from toner cartridges Ky, Km, Kc, and Kk which are examples of developer accommodation units. The toner cartridges Ky to Kk are attachably and detachably attached to a developer replenishment device U3b.

The toner images on the surfaces of the photoreceptor drums Py to Pk are sequentially transferred by primary transfer rolls T1y, T1m, T1c, and T1k, which are examples of transfer units and are examples of primary transferers, onto an intermediate transfer belt B, which is an example of an intermediate transfer unit, at primary transfer regions Q3y, Q3m, Q3c, and Q3k to be superimposed on each other. Accordingly, a color toner image which is an example of a multi-color visible image is formed on the intermediate transfer belt B. The color toner image formed on the intermediate transfer belt B is transported to a secondary transfer region Q4.

In addition, in a case where there is only image information for black, only the photoreceptor drum Pk and the developing device Gk for black are used, so that only a black toner image is formed.

Residues such as residual developer and paper dust adhering to the surfaces of the photoreceptor drums Py to Pk after primary transfer are removed by drum cleaners CLy, CLm, CLc, and CLk which are examples of cleaning units for image holding units.

In Example 1, the photoreceptor drum Pk, the charging roll CRk, and the drum cleaner CLk are integrated with each other as a photoreceptor unit UK for black, which is an example of an image holder unit. In addition, regarding the other colors which are yellow, magenta, and cyan as well, the photoreceptor drums Py, Pm, and Pc, the charging rolls CRy, CRm, and CRc, and the drum cleaners CLy, CLm, and CLc constitute photoreceptor units UY, UM, and UC.

In addition, the photoreceptor unit UK for black and the developing device Gk that includes a developing roll ROk, which is an example of a developer holding unit, constitute an image formation unit UK+Gk for black. Similarly, the photoreceptor units UY, UM, and UC for yellow, magenta, and cyan and the developing devices Gy, Gm, and Gc that include developing rolls R0y, R0m, and R0c constitute image formation units UY+Gy, UM+Gm, and UC+Gc for yellow, magenta, and cyan, respectively.

A belt module BM which is an example of an intermediate transfer unit is disposed below the photoreceptor drums Py to Pk. The belt module BM includes the intermediate transfer belt B which is an example of an image holding unit, a drive roll Rd which is an example of a drive unit for the intermediate transfer unit, a tension roll Rt which is an example of a tension applying unit, a walking roll Rw which is an example of meandering prevention unit, a plurality of idler rolls Rf which are examples of driven units, a backup roll T2a which is an example of a facing unit, and the primary transfer rolls T1y to T1k. The intermediate transfer belt B is supported to be rotatable and movable in a direction along an arrow Ya.

The primary transfer rolls T1y, T1m, and T1c for yellow, magenta, and cyan in Example 1 are supported to be able to approach to and separate from the photoreceptor drums Py, Pm, and Pc. In the case of multi-color printing (color printing), the primary transfer rolls T1y, T1m, and T1c for yellow, magenta, and cyan approach to the photoreceptor drums Py to Pc so that the intermediate transfer belt B is sandwiched by a contact pressure set in advance. Meanwhile, in the case of single-color printing (monochrome printing) for black only, the primary transfer rolls T1y, T1m, and T1c are separated from the photoreceptor drums Py to Pc.

A secondary transferring unit Ut is disposed below the backup roll T2a. The secondary transferring unit Ut includes a secondary transfer roll T2b which is an example of a secondary transfer unit. A region where the secondary transfer roll T2b comes into contact with the intermediate transfer belt B forms the secondary transfer region Q4. In addition, the backup roll T2a which is the example of the facing unit faces the secondary transfer roll T2b with the intermediate transfer belt B interposed therebetween. The backup roll T2a is in contact with a contact roll T2c which is an example of an electric supply unit. A secondary transfer voltage of which the polarity is the same as toner charging polarity is applied to the contact roll T2c.

The backup roll T2a, the secondary transfer roll T2b, and the contact roll T2c constitute a secondary transferer T2 which is an example of a transfer unit.

Note that the secondary transferring unit Ut of Example 1 is configured to be movable in a direction toward the intermediate transfer belt B and a direction away from the intermediate transfer belt B. The secondary transferring unit Ut moves in accordance with the type of the recording paper sheet S to be used, so that a contact pressure between the secondary transfer roll T2b and the intermediate transfer belt B is changed. For example, in a case where thick paper is used, it is possible to alleviate an impact caused in a case where a leading end of the thick paper enters the secondary transfer region Q4 by making the contact pressure low in comparison with a case where plain paper is used.

A medium transport path SH2 is disposed below the belt module BM. The recording paper sheet S fed from the medium supply path SH1 of the feeder unit U2 is transported by transport rolls Ra, which are examples of medium transport units, to a registration roll Rr which is an example of a transport timing adjustment unit. The registration roll Rr transports the recording paper sheet S to a downstream side in accordance with a time at which a toner image formed on the intermediate transfer belt B is transported to the secondary transfer region Q4. The recording paper sheet S sent by the registration roll Rr is guided by a paper sheet guide SGr on a registration side and a before-transfer paper sheet guide SG1, and is transported to the secondary transfer region Q4.

The toner image on the intermediate transfer belt B is transferred to the recording paper sheet S by the secondary transferer T2 in a case where the toner image passes through the secondary transfer region Q4. Note that in the case of a color toner image, toner images that are primarily transferred to be superimposed on the surface of the intermediate transfer belt B are collectively and secondarily transferred to the recording paper sheet S.

The primary transfer rolls T1y to T1k, the secondary transferer T2, and the intermediate transfer belt B constitute transfer devices (transfer units) T1y to T1k+T2+B of Example 1.

The intermediate transfer belt B after the secondary transfer is cleaned by a belt cleaner CLB which is an example of a cleaning unit for the intermediate transfer unit disposed downstream of the secondary transfer region Q4. The belt cleaner CLB removes, from the intermediate transfer belt B, a residue such as developer and paper dust that remains without being transferred in the secondary transfer region Q4.

In the copying machine U of Example 1, an applying device TB which is an example of a supply unit is disposed downstream of the belt cleaner CLB in a rotation direction of the intermediate transfer belt B. The applying device TB includes a housing TB1 which is an example of an accommodation unit. The housing TB1 accommodates silica (SiO₂) powder which is an example of a transfer assisting material. Note that, the silica is used as an external additive for transfer assistance of a developer and detailed description thereof will be omitted since the silica is known in the related art. In addition, as the transfer assisting material, known materials other than silica can also be used. The transfer assisting material in the housing TB1 is held by a supply roller TB2 which is an example of an assisting material holding unit. As the supply roller TB2 rotates with the transfer assisting material held at a surface of the supply roller TB2, the transfer assisting material is applied to the intermediate transfer belt B at an application position where the supply roller TB2 and the intermediate transfer belt B come into contact with each other. The transfer assisting material applied to the intermediate transfer belt B is leveled by a leveling blade TB3 which is an example of a leveling unit.

The applying device TB of Example 1 is movable between a supply position where the supply roller TB2 comes into contact with the intermediate transfer belt B so that the transfer assisting material is supplied and a non-supply position where the supply roller TB2 is separated from the intermediate transfer belt B so that the transfer assisting material is not supplied.

In a case where the transfer assisting material is supplied to the intermediate transfer belt B, a layer of the transfer assisting material is formed on a surface of the intermediate transfer belt B and a toner image is transferred to a surface of the layer of the transfer assisting material. In comparison with a case where the layer of the transfer assisting material is not present, transfer from the intermediate transfer belt B to the recording paper sheet S is easy in a case where the layer of the transfer assisting material is present. Therefore, in a case where the recording paper sheet S is a type of paper such as Japanese paper or embossed paper which is likely to cause a transfer failure, the transfer assisting material is applied so that occurrence of the transfer failure is suppressed.

Note that the supply roller TB2 may be rotationally driven with drive transmitted from a motor which is an example of a drive unit (not shown) or may be driven by the intermediate transfer belt B to rotate.

As an example of a reading unit, a density sensor SN0 that reads an image on the surface of the intermediate transfer belt B is disposed downstream of the most downstream primary transfer roll T1k in the rotation direction of the intermediate transfer belt B.

Note that in Example 1, a configuration in which the belt cleaner CLB and the applying device TB are disposed at positions separated from each other has been described as an example. However, the present invention is not limited thereto. For example, a configuration in which a housing of the belt cleaner CLB and the applying device TB are integrated into one unit can also be adopted to achieve space saving or to facilitate replacement so that the maintainability is improved.

The recording paper sheet S on which the toner image has been transferred is guided by an after-transfer paper guide SG2 and is sent to a belt transport device BH which is an example of a medium transport unit. The belt transport device BH transports the recording paper sheet S to a fixing device F.

The fixing device F includes a heating roll Fh which is an example of a heating unit and a pressing roll Fp which is an example of a pressing unit. The recording paper sheet S is transported to a fixation region Q5, which is a region where the heating roll Fh and the pressing roll Fp come into contact with each other. In a case where the toner image on the recording paper sheet S passes through the fixation region Q5, the toner image is heated and pressed to be fixed by the fixing device F.

The image formation units UY+Gy to UK+Gk, the transfer devices T1y to T1k+T2+B, and the fixing device F constitute an image recording unit U3a which is an example of an image forming unit of Example 1.

A switching gate GT1 which is an example of a switching unit is provided downstream of the fixing device F. The switching gate GT1 selectively switches the recording paper sheet S that has passed through the fixation region Q5 to any of a discharge path SH3 on the medium processing device U4 side or a reversal path SH4. The recording paper sheet S transported to the discharge path SH3 is transported to a paper sheet transport path SH5 of the medium processing device U4. A curl correction member U4a which is an example of a warp correction unit is disposed in the paper sheet transport path SH5. The curl correction member U4a corrects a warp (a so-called curl) of the recording paper sheet S transported into the curl correction member U4a. The recording paper sheet S of which the curl has been corrected it discharged to a discharge tray TH1, which is an example of a medium discharge portion, by a discharge roll Rh, which is an example of a medium discharge member, with an image fixation surface of the paper sheet facing an upper side.

The recording paper sheet S that is caused to be transported toward the reversal path SH4 of the image creating unit U3 by the switching gate GT1 is transported to the reversal path SH4 of the image creating unit U3 through a second gate GT2 which is an example of a switching member.

In a case where the recording paper sheet S is to be discharged with the image fixation surface facing a lower side, a transport direction of the recording paper sheet S is reversed after a trailing end of the recording paper sheet S in the transport direction passes through the second gate GT2. Here, the second gate GT2 of Example 1 is composed of a thin film-shaped elastic member. Therefore, the second gate GT2 allows the recording paper sheet S transported to the reversal path SH4 to pass through the second gate GT2 once and after the recording paper sheet S that has passed through the second gate GT2 is reversed and is, so to speak, switched back, the second gate GT2 guides the recording paper sheet S toward the transport paths SH3 and SH5. Then, the switched back recording paper sheet S passes through the curl correction member U4a and is discharged to the discharge tray TH1 with the image fixation surface facing the lower side.

A circulation path SH6 is connected to the reversal path SH4 of the image creating unit U3 and a third gate GT3 which is an example of a switching unit is disposed at a connection portion between the circulation path SH6 and the reversal path SH4. In addition, a downstream end of the reversal path SH4 is connected to a reversal path SH7 of the medium processing device U4.

The recording paper sheet S transported to the reversal path SH4 through the switching gate GT1 is caused by the third gate GT3 to be transported toward the reversal path SH7 of the medium processing device U4. As with the second gate GT2, the third gate GT3 of Example 1 is composed of a thin film-shaped elastic member. Therefore, the third gate GT3 allows the recording paper sheet S transported through the reversal path SH4 to pass through the third gate GT3 once and after the recording paper sheet S that has passed through the third gate GT3 is switched back, the third gate GT3 guides the recording paper sheet S toward the circulation path SH6.

The recording paper sheet S transported to the circulation path SH6 is transported again to the secondary transfer region Q4 through the medium transport path SH2, and printing on the second surface is performed.

The elements denoted by the reference numerals “SH1” to “SH7” constitute a paper sheet transport path SH. In addition, the elements denoted by the reference numerals SH, Ra, Rr, Rh, SGr, SG1, SG2, BH, and GT1 to GT3 constitute a paper sheet transport device SU of Example 1.

### Description about Control Unit of Example 1

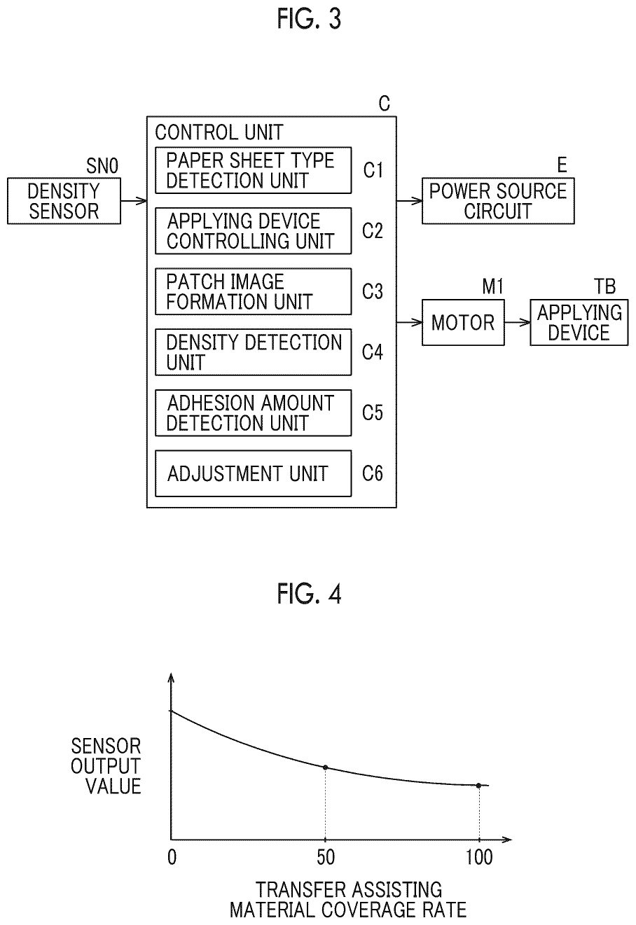

FIG. 3 is an explanatory diagram of a control unit of Example 1.

In FIG. 3, the control unit (a controller) C which is an example of a controlling unit of the copying machine U includes an input/output interface I/O through which a signal is input and output from and to the outside. In addition, the control unit C includes a read-only memory (ROM) in which a program, information, and the like for necessary processing are stored. In addition, the control unit C has a random access memory (RAM) for temporary storage of necessary data. In addition, the control unit C includes a central processing unit (CPU) that performs processing corresponding to the program stored in the ROM or the like. Therefore, the control unit C of Example 1 is composed of a small information-processing device (a so-called microcomputer). Therefore, the control unit C can realize various functions by

A signal from a signal outputting element is input to the control unit C of Example 1 and the control unit C outputs a signal to a control target element to control the control target element.

### Description about Signal Outputting Element

A signal from the signal outputting element such as the density sensor SN0 and a sensor that is not shown is input to the control unit C.

The density sensor SN0 detects the density of an image on the intermediate transfer belt B based on the amount of reflected light from the intermediate transfer belt B.

### Description about Control Target Element

The control unit C outputs a signal to the control target element such as a power source circuit E and a motor M1 which is an example of a drive unit that moves the applying device TB between the supply position and the non-supply position.

### Function of Control Unit C

The control unit C of Example 1 includes functional units (functional modules and program modules) C1 to C6 as follows.

A paper sheet type detection unit C1, which is an example of a medium type detection unit, detects, a paper type such as plain paper, thick paper, and thin paper as an example of the type of recording paper sheet S. In a case where a user inputs the type (the paper type or the size) of a recording paper sheet through the UI, the paper sheet type detection unit C1 detects type information input thereto as the type of the recording paper sheet S.

An applying device controlling unit C2 which is an example of a supply unit controlling unit controls the motor M1 such that the applying device TB is moved between the supply position and the non-supply position. In a case where the recording paper sheet S to be used is Japanese paper or embossed paper, which is an example of a type of paper that is likely to cause transfer failure set in advance, the applying device controlling unit C2 of Example 1causes the applying device TB to be moved to the supply position and in a case where the recording paper sheet S to be used is a type of paper sheet other than Japanese paper and embossed paper, the applying device controlling unit C2 causes the applying device TB to be moved to the non-supply position.

A patch image forming unit C3, which is an example of an image forming unit for image quality adjustment, controls the charging rolls CRy to CRk, the latent image forming devices ROSy to ROSk, the developing devices Gy to Gk, and the like to form a patch image, which is an example of an image for image quality adjustment. The patch image is composed of images of which the densities are set in advance, and includes, for each of yellow, magenta, cyan, and black, images of a plurality of densities. For example, the patch image includes images of a plurality of densities including low-density images and high-density images of which the densities are 5%, 25%, 50%, 75%, and 100%, so that image quality adjustment with respect to hygrothermal environment or aging deterioration can be performed precisely.

A density detection unit C4 detects the density of the patch image based on the result of detection performed by the density sensor SN0.

FIG. 4 is an explanatory diagram of an example of a relationship between the amount of adhesion of the transfer assisting material and the output of the density sensor and is a graph in which the horizontal axis represents the coverage rate and the vertical axis represents the output value of the density sensor.

An adhesion amount detection unit C5 detects the amount of adhesion of the transfer assisting material adhering to the surface of the intermediate transfer belt B. The adhesion amount detection unit C5 of Example 1 detects the amount of adhesion of the transfer assisting material based on the result of detection performed by the density sensor SN0. Specifically, the amount of adhesion can be detected based on the result of detection that is performed by the density sensor SN0 at a region on the intermediate transfer belt B where the patch image is not formed (for example, the surface of the intermediate transfer belt B before formation of the patch image or a region between images of the patch image composed of a plurality of images). As shown in FIG. 4, it has been found in advance in an experiment or the like that the detection value of the density sensor SN0 changes as the amount of adhesion of the transfer assisting material increases. Therefore, it is possible to determine the amount of adhesion of the transfer assisting material from the result of detection performed by the density sensor SN0.

An adjustment unit C6 adjusts an image quality based on the result of a patch image reading operation. The adjustment unit C6 of Example 1 adjusts, based on the result of a patch image density reading operation performed by the density sensor SN0, the density of an image to be formed. That is, in a case where the read density of the patch image is higher than the set density of the patch image, adjustment is performed such that the density of the image to be formed is made low in accordance with a difference between the densities and in a case where the read density of the patch image is low, adjustment is performed such that the density of the image to be formed is made high. The adjustment unit C6 changes any one or more of a charging bias applied to the charging rolls CRy to CRk, a development bias applied at the developing devices Gy to Gk, or the tone of images formed at the latent image forming devices ROSy to ROSk to perform image quality (density) adjustment.

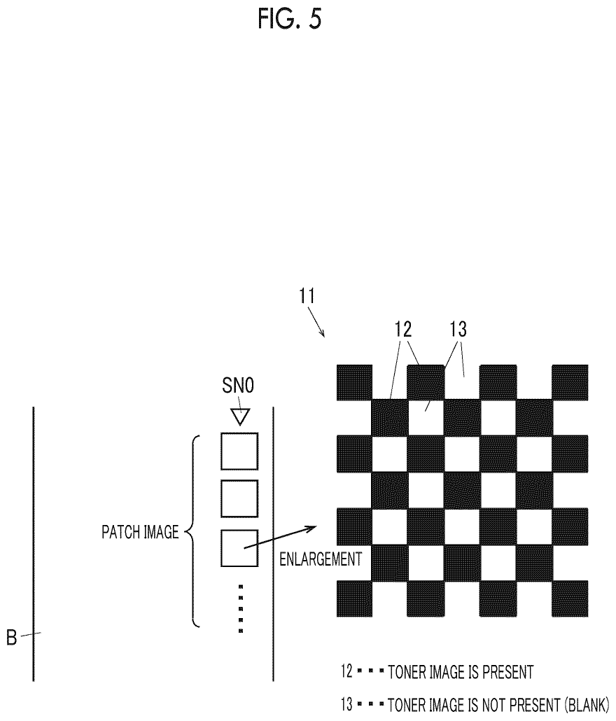

FIG. 5 is an explanatory diagram showing an influence exerted by the transfer assisting material in a case where the patch image is read.

The adjustment unit C6 of Example 1 performs adjustment in different ways depending on whether or not the transfer assisting material has been supplied to the intermediate transfer belt B. In a case where the transfer assisting material is not supplied (in a case where there is no supply of the transfer assisting material), the adjustment unit C6 of Example 1 performs image quality adjustment based on the result of a patch image reading operation. In FIG. 5, in a case where the transfer assisting material is supplied (in a case where there is supply of the transfer assisting material) and the density of the patch image is, for example, 50%, toner 12 is applied to 50% of an image region 11 and no toner is applied to remaining margin portions 13. In a case where the transfer assisting material is supplied to the intermediate transfer belt B, the transfer assisting material is applied to the margin portions 13, and the result of detection performed by the density sensor SN0 is lowered as described above in FIG. 4. That is, it is determined that images are also present in the margin portions 13. Therefore, the read density of the entire patch image becomes high in comparison with a case where the transfer assisting material is not supplied and thus image quality adjustment is performed such that the density of an image to be formed is adjusted to a low density.

With regard to this, in a case where the transfer assisting material is supplied, the adjustment unit C6 of Example 1 suppresses adjustment in which the density of the image to be formed is adjusted to the low density at the time of the image quality adjustment (suppresses the density being adjusted to an excessively low density). For example, adjustment is performed such that a final density adjustment amount α satisfies α=α1 in a case where the transferα assisting material is not supplied and satisfies α=α1−α2 in a case where the transfer assisting material is supplied, where α1 is a density adjustment amount based on the patch image and α2 is a density adjustment amount in the case of supply of the transfer assisting material.

Here, in the case of a high-density patch image, the margin portions 13 are small and the result of detection performed by the density sensor SN0 is less likely to be influenced by the transfer assisting material. However, in the case of a low-density patch image, the margin portions 13 are relatively large and the result of detection performed by the density sensor SN0 is likely to be influenced by the transfer assisting material. Therefore, at the time of image quality adjustment, the closer to a low-density side the position of adjustment is, the more likely erroneous adjustment is to be performed. The closer to a low-density side the position of adjustment is, the more likely the amount of decrease in density is to be large. With regard to this, at the time of image quality adjustment, the adjustment unit C6 of Example 1 performs adjustment such that the amount (the adjustment amount α) of decrease in density is small on the low-density side in comparison with a high-density side. For example, the adjustment is performed such that α21<α22 and (the adjustment amount α on the high-density side=α1−α21)>(the adjustment amount α on the low-density side=α1−α22), where α21 is an adjustment amount on the high-density side and α22 is an adjustment amount on the low-density side with respect to the adjustment amount α2 in the case of supply of the transfer assisting material

In addition, in the adjustment unit C6 of Example 1, whether or not the transfer assisting material has been supplied is determined based on the result of detection performed by the adhesion amount detection unit C5. That is, in a case where the adhesion amount detection unit C5 determines that the transfer assisting material has not adhered to the surface of the intermediate transfer belt B, it is determined that the transfer assisting material has not been supplied and image quality adjustment to be performed in a case where the transfer assisting material is not supplied is performed. Meanwhile, in a case where it is determined that the transfer assisting material has adhered to the surface of the intermediate transfer belt B, it is determined that the transfer assisting material has been supplied and image quality adjustment to be performed in a case where the transfer assisting material is supplied is performed.

Note that, a configuration in which the adjustment amount (an adjustment value) α2 in the case of supply of the transfer assisting material is determined in accordance with the amount of adhesion detected by the adhesion amount detection unit C5 can also be adopted. That is, it is also possible to increase the value of the adjustment amount α2 in a case where the amount of adhesion is large and to decrease the value of the adjustment amount α2 in a case where the amount of adhesion is small. In comparison with a case where the adjustment amount is constant regardless of the amount of adhesion, the precision of image quality adjustment may be further improved in a case where the adjustment is determined in accordance with the amount of adhesion.

In addition, although whether or not the transfer assisting material has been supplied is determined based on the result of detection performed by the adhesion amount detection unit C5 in the case of the adjustment unit C6 of Example 1, the present invention is not limited thereto. For example, it may be determined that the transfer assisting material has been supplied in a case where the applying device TB has been moved to the supply position and it may be determined that the transfer assisting material has not been supplied in a case where the applying device TB has been moved to the non-supply position. Alternatively, it may be determined that the transfer assisting material has been supplied in a case where the type of the recording paper sheet S to be used is Japanese paper or embossed paper which is a type of medium of which use leads to supply of the transfer assisting material and it may be determined that the transfer assisting material has not been supplied in a case where the type of the recording paper sheet S is a type of paper other than Japanese paper and embossed paper. In a case where the determination is performed based on the position of the applying device TB or the type of paper, it is not necessary to detect the amount of adhesion, and a configuration and control can be simplified. Meanwhile, for example, in a case where the type of paper is switched from Japanese paper or the like to plain paper, the transfer assisting material supplied at the time of printing performed on the Japanese paper may remain on the intermediate transfer belt B and it may be determined, because of the type of paper being plain paper, that the transfer assisting material has not been supplied although the transfer assisting material remaining on the intermediate transfer belt B is present, which may result in inappropriate image quality adjustment. However, in a case where the determination is performed based on the amount of adhesion, appropriate adjustment can be performed even in a case where the type of paper is switched. Note that it is also possible to perform a combination of two or more or all of determination based on the amount of adhesion, determination based on the position of the applying device TB, or determination based on the type of paper and to perform determination while giving priorities to the three determination methods.

In the adjustment unit C6 of Example 1, regarding the density adjustment value α1 based on the read density of the patch image, existing density adjustment can be used as it is. However, in the case of supply of the transfer assisting material, the adjustment is excessive and α2 is used to suppress excessive adjustment. However, adjustment is not limited to adjustment of the adjustment amount a of the density of an image to be formed and, for example, adjustment of an output value, which is the result of a reading operation performed by the density sensor SN0, can also be performed. An output value β of the density sensor SN0 is an output value β1 without an influence exerted by the transfer assisting material in a case where the transfer assisting material is not supplied. However, in a case where there is an influence exerted by the transfer assisting material, the output value β of the density sensor SN0 satisfies β=β1+Δβ, where Δβ corresponds to the influence exerted by the transfer assisting material. Therefore, in a case where the transfer assisting material is supplied, it is possible to suppress an adverse effect of the transfer assisting material by adjusting and correcting the output value β of the density sensor to β−Δβ and determining the density adjustment value α1 based on β−Δβ. Therefore, a configuration in which the output value of the density sensor SN0 is adjusted based on whether or not the transfer assisting material has been supplied can also result in suppression of the adverse effect of the transfer assisting material.

### Action of Example 1

In the copying machine U of Example 1 configured as described above, in a case where the transfer assisting material is supplied to the intermediate transfer belt B, excessive-density adjustment is suppressed to cope with an adverse effect on the result of detection performed by the density sensor SN0. That is, although there is a problem that an adverse effect of the transfer assisting material makes the image quality adjustment inappropriate and the image quality is made unstable in the related art in which a patch held at the intermediate transfer belt B is read and image quality adjustment is performed regardless of whether or not the transfer assisting material has been supplied to the intermediate transfer belt B, in Example 1, the excessive-density adjustment is suppressed and the image quality is stabilized.

### Modification Examples

Hereinabove, the example of the present invention has been described in detail. However, the present invention is not limited to the above example and various modifications can be made within the scope of the gist of the present invention described in the claims. Modification examples (H01) and (H02) of the present invention will be described below.

(H01) In the above-described examples, the copying machine U which is an example of the image forming apparatus has been described. However, the present invention is not limited thereto and application to a fax machine or application to a multifunction machine having a plurality of functions of a fax machine, a printer, a copying machine, and the like is also possible. In addition, the present invention is not limited to a multi-color development image forming apparatus and a monochromatic image forming apparatus, that is, a so-called monochrome image forming apparatus may also be adopted. Furthermore, the present invention is not limited to the image forming apparatus, and the present invention can also be applied to any electronic device or mechanical device in which a motor and gears are used.

(H02) In the above-described examples, the intermediate transfer belt B has been described as an example of an image holding unit. However, the present invention is not limited thereto and application to a photoreceptor or the like is also possible. Therefore, the image holding unit is not limited to a belt-shaped member and application to a drum-shaped member is also possible.

### Supplementary Note

(((1)))
An image forming apparatus comprising:
an image holding unit;
a transfer unit that transfers an image held by the image holding unit to a medium;
a reading unit that reads an image held by the image holding unit;
a supply unit that supplies, to the image holding unit, a transfer assisting material that assists transfer; and
an adjustment unit that performs adjustment of an image quality based on a result of a reading operation performed by the reading unit on an image for image quality adjustment, which is held by the image holding unit, and that performs the adjustment in different ways depending on whether or not the transfer assisting material has been supplied to the image holding unit.

(((2)))
The image forming apparatus according to (((1))
wherein determination on whether or not the transfer assisting material has been supplied is performed based on a result of a reading operation in which the image holding unit at which the image for image quality adjustment is not held is read by the reading unit.

(((3)))
The image forming apparatus according to (((1))) or (((2))), further comprising:
an adhesion amount detection unit that detects an amount of adhesion of the transfer assisting material to the image holding unit,
wherein the adjustment unit that determines an adjustment value at a time of adjustment in accordance with the amount of adhesion is provided.

(((4)))
The image forming apparatus according to any one of (((1))) to (((3))),
wherein the supply unit that is movable between a supply position where the transfer assisting material is supplied to the image holding unit and a non-supply position where the transfer assisting material is not supplied to the image holding unit is provided, and
determination on whether or not the transfer assisting material has been supplied is performed based on a position of the supply unit.

(((5)))
The image forming apparatus according to any one of (((1) to ((4)),
wherein determination on whether or not the transfer assisting material has been supplied is performed based on whether or not a type of medium determined in advance, of which use leads to supply of the transfer assisting material, is used as the medium.

(((6)))
The image forming apparatus according to any one of (((1))) to (((5))),
wherein the adjustment unit that adjusts a density of an image to be formed based on whether or not the transfer assisting material has been supplied is provided.

(((7)))
The image forming apparatus according to (((6))),
wherein the adjustment unit that performs adjustment, in which a decrease in density of the image to be formed is suppressed in comparison with a case where the transfer assisting material is not supplied, in a case where the transfer assisting material is supplied is provided.

(((8)))
The image forming apparatus according to (((7))),
wherein the adjustment unit that makes an amount of decrease in density of the image to be formed at a low-density side portion of the image to be formed small in comparison with an amount of decrease in density at a high-density portion is provided.

(((9)))
The image forming apparatus according to any one of (((1))) to (((8))),
wherein the adjustment unit that adjusts an output value of the reading unit based on whether or not the transfer assisting material has been supplied is provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holding unit;
a transfer unit that transfers an image held by the image holding unit to a medium;
a reading unit that reads an image held by the image holding unit;
a supply unit that supplies, to the image holding unit, a transfer assisting material that assists transfer; and
an adjustment unit that performs adjustment of an image quality based on a result of a reading operation performed by the reading unit on an image for image quality adjustment, which is held by the image holding unit, and that performs the adjustment in different ways depending on whether or not the transfer assisting material has been supplied to the image holding unit.

2. The image forming apparatus according to claim 1,
wherein determination on whether or not the transfer assisting material has been supplied is performed based on a result of a reading operation in which the image holding unit at which the image for image quality adjustment is not held is read by the reading unit.

3. The image forming apparatus according to claim 2, further comprising:
an adhesion amount detection unit that detects an amount of adhesion of the transfer assisting material to the image holding unit,
wherein the adjustment unit that determines an adjustment value at a time of adjustment in accordance with the amount of adhesion is provided.

4. The image forming apparatus according to claim 1,
wherein the supply unit that is movable between a supply position where the transfer assisting material is supplied to the image holding unit and a non-supply position where the transfer assisting material is not supplied to the image holding unit is provided, and
determination on whether or not the transfer assisting material has been supplied is performed based on a position of the supply unit.

5. The image forming apparatus according to claim 1,
wherein determination on whether or not the transfer assisting material has been supplied is performed based on whether or not a type of medium determined in advance, of which use leads to supply of the transfer assisting material, is used as the medium.

6. The image forming apparatus according to claim 1,
wherein the adjustment unit that adjusts a density of an image to be formed based on whether or not the transfer assisting material has been supplied is provided.

7. The image forming apparatus according to claim 6,
wherein the adjustment unit that performs adjustment, in which a decrease in density of the image to be formed is suppressed in comparison with a case where the transfer assisting material is not supplied, in a case where the transfer assisting material is supplied is provided.

8. The image forming apparatus according to claim 7,
wherein the adjustment unit that makes an amount of decrease in density of the image to be formed at a low-density side portion of the image to be formed small in comparison with an amount of decrease in density at a high-density portion is provided.

9. The image forming apparatus according to claim 1,
wherein the adjustment unit that adjusts an output value of the reading unit based on whether or not the transfer assisting material has been supplied is provided.

10. An image forming apparatus comprising:
image holding means;
transfer means for transferring an image held by the image holding means to a medium;
reading means for reading an image held by the image holding means;
supply means for supplying a transfer assisting material that assists the transfer to the image holding means; and
adjustment means for performing adjustment of an image quality based on a result of a reading operation performed by the reading means on an image for image quality adjustment, which is held by the image holding means, and performing the adjustment in different ways depending on whether or not the transfer assisting material has been supplied to the image holding means.
